(19) United States
(12) Patent Application Publication
(10) Pub. No.: US 2024/0430501 A1
(43) Pub. Date: Dec. 26, 2024

(54) SYSTEMS AND METHODS FOR BANDWIDTH CONTROL BASED ON FIELD OF VISION FOR MULTIPLE AR AND PHYSICAL TELEVISIONS

(71) Applicant: Adeia Guides Inc., San Jose, CA (US)

(72) Inventor: Christopher Phillips, Hartwell, GA (US)

(21) Appl. No.: 18/214,119

(22) Filed: Jun. 26, 2023

(51) Int. Cl. H04N 21/2385; H04L 65/75; H04N 21/239; H04N 21/41; H04N 21/414

(52) U.S. Cl. CPC H04N 21/2385; H04L 65/75; H04N 21/2393; H04N 21/4122; H04N 21/41407

(57) ABSTRACT

Systems and methods for managing bandwidth in a network containing physical displays of electronic devices and virtual displays provided via an extended reality (XR) device are provided. A plurality of content streams are provided to the plurality of displays and a bandwidth amount is assigned to each content stream of the plurality of streams. A field of vision of the user of the XR device is determined and a subset of the plurality of displays that are in the field of vision of the user are determined. The bandwidth amount assigned to at least one of the plurality of content streams is adjusted based on the subset of the plurality of displays that are in the field of vision of the user.

### BACKGROUND

The present disclosure is directed towards systems and methods for controlling display playback via an extended reality device. In particular, systems and methods are provided herein for enabling a bandwidth of a content item to be manipulated in a manner responsive to the extent to which a display falls within the field of view of an extended reality display device.

### SUMMARY

Content consumers frequently may want to consume multiple content items at the same time (e.g., from one or more over-the-top (OTT) providers). For example, a television viewer may want to watch multiple sports events which are concurrently occurring. On a college gameday, there may be multiple games taking place at the same time. In order to watch all the games, some college sports fans may switch channels frequently. Other users may put multiple physical televisions in the same room, or use a tablet and/or a smart phone. In addition, some televisions have a picture in picture (PiP) mode, and some users may use the PiP mode to watch multiple games. Some televisions also enable multiple channels to be viewed in a grid type layout, which some users may use to watch multiple games. While the aforementioned examples may enable a user to consume multiple content items at the same time, none of the examples is an ideal solution. Switching channels may require the viewer to miss segments while switching. In addition to it being physically unwieldy to move multiple televisions into the same room, there tends to be a high bandwidth cost associated with consuming multiple content items on different devices at the same time. This bandwidth cost increases with time, as more content is available at ever higher resolutions including, for example, live sports in 8K at 60p. While content can be compressed, to an extent, as the compression is increased user quality of experience tends to decrease. Consuming content in a PiP mode, or via multiple channels in a grid layout, on a single television also leads to reduced quality of experience, as the images of the different content items tend to be small, it can be difficult to follow, for example, different plays in each of the games being consumed. Typically, users prefer to watch, for example, their main game on a single screen, rather than dividing the screen up and showing multiple games.

Extended reality (XR) systems, such as augmented reality (AR) and virtual reality (VR) systems, can allow viewers to place virtual display screens in a spatially mapped environment with each screen playing a different channel. For example, these virtual screens can be video player windows, which, e.g., each look like a television. However, if all the virtual screens are placed within the same field of view, it limits the resolutions on each of the screens and is effectively the same as a grid layout or video mosaic on a single television. An alternative is to locate virtual screens at multiple locations around, for example, a room in a user's home, allowing the user to turn their head to watch each screen; however, this can also lead to a high bandwidth cost in a similar manner to that discussed above. In some instances, XR users may consume content on a mixture of physical displays and virtual displays.

Watching multiple channels at once may create bandwidth issues. For example, Multicast Adaptive Bitrate Streaming (MABS) allows for more channels to be streamed over existing infrastructure in the case of cable and internet protocol television (IPTV). A viewer simultaneously streaming multiple high-quality multimedia programs can use a significant amount of available bandwidth. Every device on the network must compete for bandwidth. If the required combined bandwidth to stream these programs exceeds the available throughput, there can be many problems including blurring and artifacts in the videos, buffer underrun for one or more streams, low quality for all the streams, etc. Additionally, if several subscribers simultaneously stream multiple programs at full resolution and full speed, then servers and/or head-ends of multiple content delivery systems may be taxed too much. Some approaches to stream multiple programs may lower the bandwidth for each display to ensure all programs may be streamed to a corresponding display resulting in a poor experience. Some approaches may limit the number of available streams to, e.g., four or five. Some approaches may limit the number of high-quality displays to a number, e.g., one or two. Some approaches may require a viewer to manually designate one or more high quality displays, e.g., pressing a button when focusing on each specific program, which could almost be as slow as changing channels manually. There exists a need to automatically optimize bandwidth for multiple streams consumed via physical and virtual displays.

To overcome these problems, systems and methods are provided herein for controlling bandwidth allocation for a mixture of extended reality devices and physical devices. For instance, more bandwidth may be allocated for physical and virtual displays within a user's field of vision, e.g., at a given time, while less bandwidth may be allotted for displays outside of the field of vision at that time.

One or more disclosed embodiments enable bandwidth management for a network with multiple displays including, for example, physical displays and virtual displays (e.g., XR displays) based on the user's field of vision. For instance, the quality of experience (QoE) can be optimized by applying a bandwidth management algorithm which increases the bandwidth for displays or streams within the user's field of vision. Bandwidth may be allocated or adjusted based on other factors in addition to (or instead of) field of vision. For example, bandwidth allocation for a given display or stream may be allocated or adjusted based on the size of the display(s) in question, spatial distance between a position of a display and a position of the user's XR device (e.g., an XR headset), or a viewing angle between the user or XR device and the display or stream in question. Bandwidth management algorithms can be applied at multiple locations in the content delivery system.

In an example, a user may be watching multiple football games at one time. The user may focus on the display showing their favorite team playing. However, the user may change their focus to a game which is in the fourth quarter and tied. There may not be enough bandwidth for all of the TVs in the room to stream, so bandwidth is allocated toward streams which the user is focused on.

Systems and methods are provided herein for managing a bandwidth in a network. In accordance with some aspects of the disclosure, a method is provided that includes providing a plurality of content streams via a plurality of displays comprising at least one physical display of an electronic device and at least one virtual display provided via an extended reality (XR) device. A bandwidth amount is assigned to each content stream of the plurality of streams and a field of vision of a user of the XR device. A subset of the plurality of displays that are in the field of vision of the user is determined and the bandwidth amount assigned to at least one of the plurality of content streams is adjusted based on the subset of the plurality of displays that are in the field of vision of the user.

In an example system comprising a physical display of an electronic device and an XR device, the XR device may determine a field of vision of a user of the XR device. A network device may then provide a plurality of content streams via a plurality of displays comprising at least the physical display of the device and a virtual display provided via the XR device. It may then determine a subset of the plurality of displays that are in the field of vision of the user, assign a bandwidth amount to each content stream of the plurality of streams, and then adjust the bandwidth amount assigned to at least one of the plurality of content streams based on the subset of the plurality of displays that are in the field of vision of the user.

In some embodiments, an updated field of vision of the user is determined and a second subset of the plurality of displays are determined to be in the updated field of vision of the user. Based on this determination, the bandwidth amount assigned to at least one of the plurality of content streams is adjusted.

In some embodiments, based on determining that at least one of the plurality of content streams is provided via a display in the subset of the plurality of displays that are in the field of vision of the user, the bandwidth amount assigned to that stream is increased. In some embodiments, based on determining that at least one of the plurality of content streams is provided via a display which is not in the subset of the plurality of displays that are in the field of vision of the user, the bandwidth amount assigned to that stream is decreased.

In some embodiments, a user may send a request to view a first content stream at the virtual display provided via the XR device. In some embodiments, a user may send a request to view a second content stream at the physical display of the electronic device.

In some embodiments, the bandwidth amount assigned to at least one of the plurality of content streams is adjusted based on a size of each display of the plurality of displays. In other embodiments, the bandwidth amount assigned to at least one of the plurality of content streams is adjusted based on a distance from the XR device to each display of the plurality of displays. In other embodiments, the bandwidth amount assigned to at least one of the plurality of content streams is adjusted based on a content type of the content stream.

In some embodiments, the subset of the plurality of displays that are in the field of vision of the user is determined by determining a position for each display of the plurality of displays, determining coordinates for the field of vision of the user, and determining, for each display of the plurality of displays, whether the respective position is within the coordinates for the field of vision of the user.

In some embodiments, a user may indicate that they wish to designate a first content stream of the plurality of content streams as a priority stream. Based on this indication, when adjusting the bandwidth amount assigned to at least one of the plurality of content streams, the bandwidth amount assigned to priority stream is not adjusted.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows an example environment in which bandwidth allocation for streams on virtual displays and physical devices is managed based on the field of vision of an extended reality device, in accordance with some embodiments of the disclosure;

FIG. 2 shows another example environment in which bandwidth allocation for streams on virtual displays and physical devices is managed based on the field of vision of an extended reality device, in accordance with some embodiments of the disclosure;

FIG. 3 shows another example environment in which bandwidth allocation for streams on virtual displays and physical devices is managed based on the field of vision of an extended reality device, in accordance with some embodiments of the disclosure;

FIG. 4 shows another example environment in which bandwidth allocation for streams on virtual displays and physical devices is managed based on the field of vision of an extended reality device, in accordance with some embodiments of the disclosure;

FIG. 5 shows another example environment in which bandwidth allocation for streams on virtual displays and physical devices is managed based on the field of vision of an extended reality device, in accordance with some embodiments of the disclosure;

FIG. 6 shows another example environment in which bandwidth allocation for streams on virtual displays and physical devices is managed based on the field of vision of an extended reality device, in accordance with some embodiments of the disclosure;

FIG. 7 shows another example environment in which bandwidth allocation for streams on virtual displays and physical devices is managed based on the field of vision of an extended reality device, in accordance with some embodiments of the disclosure;

FIG. 8 shows a flowchart of illustrative steps involved in managing bandwidth in a networking including physical devices and XR devices, in accordance with some embodiments of the disclosure;

FIG. 9 shows a flowchart of illustrative steps involved in identifying physical TVs, in accordance with some embodiments of the disclosure;

FIG. 10 shows a flowchart of illustrative steps involved in adjusting the bandwidth for physical and AR TVs based on weight changes, in accordance with some embodiments of the disclosure;

FIG. 11 shows a flowchart of illustrative steps involved in changing AR virtual TV channels or physical TV or STB channels, in accordance with some embodiments of the disclosure;

FIG. 12 shows a flowchart of illustrative steps involved in adding or deleting AR virtual TVs, in accordance with some embodiments of the disclosure;

FIG. 13 shows a block diagram representing computing device components and dataflow therebetween for managing bandwidth in a network with an extended reality device and physical device, in accordance with some embodiments of the disclosure.

### DETAILED DESCRIPTION

Systems and methods are described herein for controlling display playback via a mixture of an extended reality device and physical devices. An extended reality device includes any computing device that enables the physical world to be augmented with one or more virtual objects and/or enables physical and virtual objects to interact with one another. Extended reality devices include augmented reality devices and mixed reality devices. Virtual reality devices that enable physical objects to passthrough into a virtual world are also contemplated. A display includes both physical and virtual displays and is anything that is capable of generating and displaying an image and/or video from an input. A physical display typically includes the screens of devices such as televisions, computer monitors, tablets and smartphones. A virtual display is anything that is generated by an extended reality device for displaying an image and/or video from an input. The input may, for example, be a content item stream wirelessly received at a radio and/or receiver of the extended reality device. A virtual display may comprise solely the output generated from a content item, for example, a borderless video projected onto the physical world. In another example, a virtual display may comprise one or more virtual elements to make the virtual display appear in a similar manner to a traditional display, such as a television. Manipulating the quality of a content item includes requesting a different, or changing the resolution, framerate and/or bandwidth of a content item and/or a segment of a content item.

A content item may include audio, video, text and/or any other media content. A content item may be a single media content item. In other examples, it may be a series (or season) of episodes of media content items. Audio includes audio-only content, such as podcasts. Video includes audiovisual content such as movies and/or television programs. Text includes text-only content, such as event descriptions. One example of a suitable media content item is one that complies with an adaptive bitrate standard, such as the MPEG DASH or the HLS standards. An OTT, streaming and/or VOD service (or platform) may be accessed via a website and/or an app running on a computing device, and the device may receive any type of content item, including live content items and/or on-demand content items. Content items may, for example, be streamed to physical computing devices. In another example, content items may, for example, be streamed to virtual computing devices in, for example, an augmented environment, a virtual environment and/or the metaverse.

The disclosed methods and systems may be implemented on one or more computing devices. As referred to herein, the computing device can be any device comprising a processor and memory, for example, a television, a smart television, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, a smartwatch, a smart speaker, an augmented reality device, a mixed reality device, a virtual reality device, or any other television equipment, computing equipment, or wireless device, and/or combination of the same.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory, including, but not limited to, volatile and non-volatile computer memory or storage devices such as a hard disk, floppy disk, USB drive, DVD, CD, media cards, register memory, processor caches, random access memory (RAM), etc.

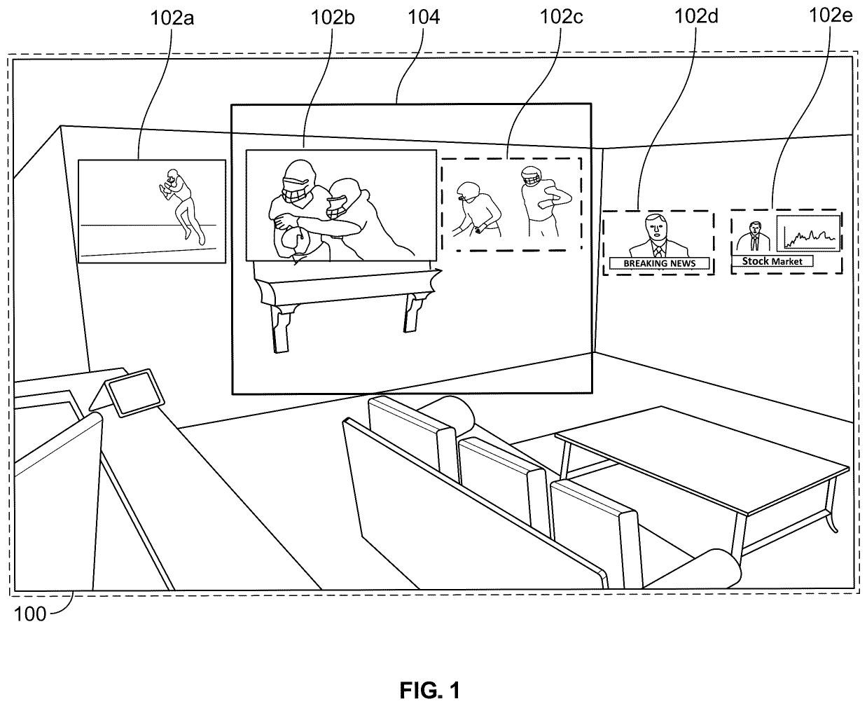

FIG. 1 shows an example environment in which bandwidth allocation for streams on virtual displays and physical devices is managed based on the field of vision of an extended reality device, in accordance with some embodiments of the disclosure. The environment 100 is an example of a spatially mapped room that comprises two physical displays 102a, 102b and three virtual displays 102c, 102d, 102e. For instance, physical display 102a might feature a first football game (e.g., a nationally televised game), physical display 102a might feature a second football game (e.g., with a favorite team), virtual display 102c might display a third football game (e.g., a really close game about to finish), virtual display 102d might display a news program, and virtual display 102e might feature a business news program. In some embodiments, each display can change programs (e.g., channels) that are displayed. In some embodiments, virtual displays may be moved around and/or placed anywhere the viewer might look.

In some embodiments, each stream may be set to an initial bandwidth. For example, the football games on displays 102a, 102b, and 102c might be streamed at, e.g., 1920×1080 resolution and 4300 kbps each, while the news programs on virtual displays 102d and 102e might be streamed at, e.g., 1280×720 resolution and 2350 kbps each.

In environment 100, using the physical displays and the virtual displays, a user can watch several programs at one time by swiveling her head from display to display, e.g., as a relevant, important, and/or urgent event is televised on each individual display. For example, a viewer may be primarily focusing on her favorite football team on display 102b but may focus on display 102c as the time winds down on a close game and/or periodically turn her head towards display 102a if there is a big play in a nationally televised game. In some cases, the viewer may turn towards display 102d when there is breaking news and potentially focus on display 102e to see how the market is reacting.

The area indicated by box 104 is an example field of view of a head-mounted extended reality device, which is based on the position of the user's head. For example, an XR device may track the gaze of the user or the head orientation of the user, or may use any other suitable method for determining whether the user's attention is focused. In some examples, the extended reality device may comprise means for eye tracking, which may to determine where the user is looking in the field of view. In some embodiments, one or more accelerometers, inertial measurement units, compasses, gyroscopes, or other motion detection circuitry may track movement of the XR display device. Some embodiments may also use imaging sensors to track the perceived movement of objects or anchor points within the location as the AR display device moves. Based on a determined gaze point or head orientation, as well as a known angular measurement(s) for the view, an area within the field of view may be determined, e.g., for a spatially mapped room.

Any generated factors and/or weights may be generated, at least in part, on where the user is looking in the field of view. In this example, both physical display 102b and virtual display 102c fall within the field of view and play back respective content items, for example a live television stream, a time-shifted television stream and/or a VOD stream. Physical display 102a and virtual displays 102d and 102e fall outside of the field of view. In this example, physical display 102a receives a content item via VOD or via a live television stream. Virtual display 102d receives a content item via live multicast adaptable bitrate stream or an OTT stream. Virtual display 102e receives a content item via live multicast adaptable bitrate stream or an OTT stream. In this example, 102a, 102d and 102e continue to stream despite being outside of the field of vision indicated by box 104, but with a lower priority for bandwidth. For example, 102a, 102d and 102e may have a lower weight applied when the bandwidth for the stream associated with the content is allocated. 102b and 102c stream with a higher priority for bandwidth because they fall within the field of vision.

As with any of the example environments and systems described herein, on spatially mapping a room, the extended reality device may generate one or more virtual displays. In some examples, the extended reality device automatically determines where to place the one or more virtual displays in the room, for example, with respect to a physical display. In other examples, a user provides input to the extended reality device in order to manually place the one or more virtual displays. In further examples, the extended reality device may provide the user with choices of where to place the one or more virtual displays in the room and/or enable a user to “snap” the position of virtual display, to aid with optimal placement of the virtual display.

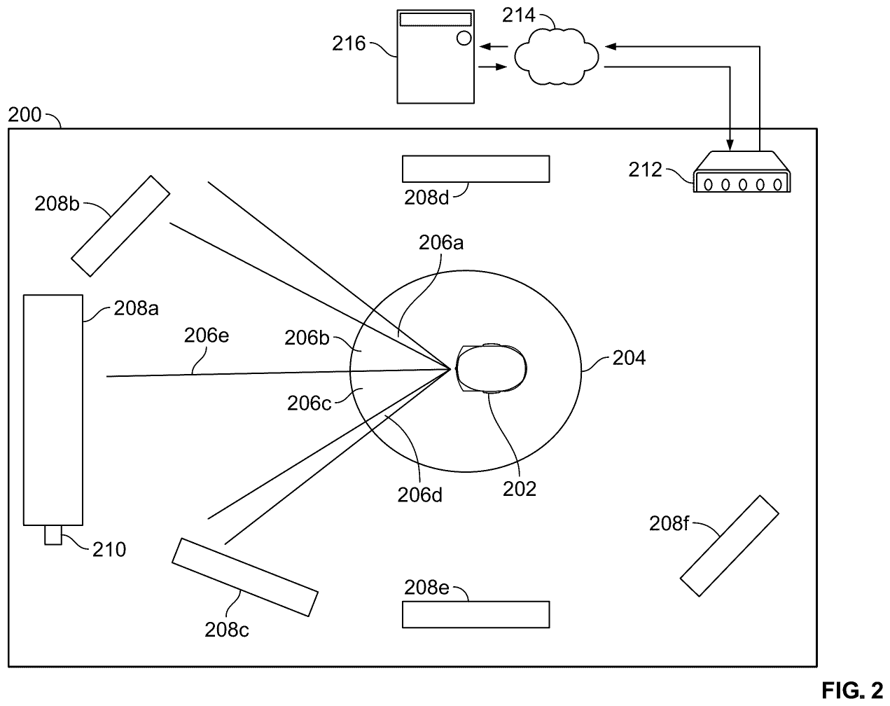

FIG. 2 shows another example environment in which bandwidth allocation for streams on virtual displays and physical devices is managed based on the field of vision of an extended reality device, in accordance with some embodiments of the disclosure. The environment comprises a room 200. The room 200 comprises an extended reality device, such as augmented reality device 202, a physical television 208a, virtual televisions 208b, 208c, 208d, 208e, 208f and a smart television device 210 that does not comprise a display. In addition, a modem 212 transmits content and data to and from the devices 202, 208a, 208b, 208c, 208d, 208e, 208f via network 214 to a server 216. The room 200 is spatially mapped by the augmented reality device 202, and any physical devices, such as television 208a and device 210 are identified. In addition, the augmented reality device 202 generates a plurality of virtual displays 208b, 208c, 208d, 208e, 208f, which are virtually placed around the room 200. Typically, a user wearing augmented reality device 204 may move freely around the room and/or in a 360° circle 204. Any virtual displays may be static and/or move as the user moves. The augmented reality device has a field of view, in this example, comprising segments 206a, 206b, 206c, 206d, in which virtual devices can be generated and displayed and physical devices can be detected. Typically, the field of view of an augmented reality device 202 is smaller than that of the user. Each of the physical devices 202, 208a, 210, including the augmented reality device, may receive content items directly via, for example, a cable connection and/or via one or more applications running on the devices 202, 208a, 210, for example via an application of an OTT provider.

The augmented reality device 202 determines an extent to which each of the plurality of displays falls within the field of view of the extended reality display device. In some examples, this may be determined at an operating system level at the augmented reality device 202. In other examples, this may be determined via an application running on the augmented reality device 202. In some examples, this may be determined remote from the augmented reality device, for example at server 216. A plurality of factors may be generated based on the determined extent to which of the displays 208a, 208b, 208c, 208d, 208e, 208f fall within the field of view defined by segments 206a, 206b, 206c, 206d, each factor corresponding to a different display of the plurality of displays. For example, a higher weighting of one may be assigned to displays that fall within the field of view of the augmented reality device 202, and a lower weighting may be assigned to displays that fall outside of the field of view of the augmented reality device 202. In this example, displays 208a, 208b and 208c may be assigned a weighting of one, and displays 208d, 208e and 208f may be assigned a weighting of zero. In another example, the weightings may not be binary and may be any value, based on any number of different factors, such as to what extent a display falls within the field of view of the extended reality device and/or the viewing angle of a display compared to a normal line 206e, within the field of view of the extended reality device (e.g., a weighting may be based on which of the segments 206a, 206b, 206c, 206d that a display falls in). For at least one display of the plurality of displays, the bandwidth of the stream for the content item is manipulated in a manner responsive to the extent to which the at least one display falls within the field of view, based on the display's presence in the field of vision of the user. For example, the content stream delivered to virtual displays 208d, 208e and 208f may be allocated a lower bandwidth because they have a weighting of zero associated with them. In this manner, the bandwidth that was originally occupied by those devices is now available for delivering content items to the devices within the field of view of the augmented reality device 202, including any physical displays that fall within the field of view of the extended reality device. In some examples, the quality of content items may be reduced based on the factors, or weights. For example, the quality of the content items delivered to displays 208b and 208c may be reduced because they fall within the peripheral segments 206a, 206d. The factors, or weights, may be updated in response to a detected movement, such as a head movement and/or eye movement, of the user, at regular periods and/or in response to a received trigger, such as a command from a server.

In some examples, physical display 208a may by an 8K smart television, virtual display 208b may be a virtual 40-inch television, virtual display 208c may be a virtual 60-inch television, virtual display 208d may be a virtual 50-inch television, virtual display 208e may be a virtual 46-inch television, and virtual display 208f may be a virtual 32-inch television. Although only one physical display 208a is shown in this example, any number of physical devices may be used. The modem 212 may be a 5G fixed wireless access, cable or digital subscriber line modem that is connected to the augmented reality device 202, the physical television 208a and/or the smart television device 210 via Wi-Fi and/or wired means. Data that is transmitted to and from the model to the devices 202, 208a, 210 includes content item data and play requests from each of the physical and/or virtual devices. In some examples, the extended reality device may utilize eye tracking to determine which display, or displays, the user is looking at. This may be achieved by tracking an angle between the direction a user's eye is looking and one or more points on a spatial map of the room 200. In some examples, each of the displays 208a, 208b, 208c, 208d, 208e, 208f may have a spatial central point of reference assigned to it, for example, spatial tag coordinates located at the center of the physical and/or virtual displays, which may be used to determine whether or not a display falls within the field of view of an extended reality device. In other examples, the entire width of a display may be used to determine whether or not a display falls within the field of view of the extended reality device. In some examples, different weights may be assigned depending on whether the device falls within a particular segment of the field of view of the augmented reality device 202. For example, peripheral segments 206a and 206d may have a lower weight, for example, a weight of 2.5, associated with them than central segments 206b and 206c, for example, a weight of five.

In some examples, segment 206a may be associated with a viewing angle of, e.g., 26°-36° with respect to normal line 206e. Segment 206b may be associated with a viewing angle of 0°-25° with respect to normal line 206e. Segment 206c may be associated with a viewing angle of, e.g., 335°-359° with respect to normal line 206e. Segment 206d may be associated with a viewing angle of, e.g., 324°-334° with respect to normal line 206e. These angles for the field of view could change, or be calculated, based on the user's augmented reality device 202 field of vision. For example, augmented reality virtual displays may only be seen within the augmented reality display viewport, which may be very narrow for augmented reality head-mounted displays. The field of view see-through portion of the augmented reality display may be much greater than the augmented reality device rendering viewport. For range calculations involving a physical display, generated factors, or weights, may be increased by applying a physical device factor range offset, or have a totally different range metric, to take into account the difference in fields of view. For example, a different field-of-view angle may be utilized for assessing where the spatial anchor for physical displays falls in the field of view, for example by increasing the angle by 15°-25°, or more, for physical displays.

In some examples, the factors, or weightings, may also be determined based on a distance of the display 208a, 208b, 208c, 208d, 208e, 208f from the augmented reality device 202. The distance may be a physical and/or spatial (virtual) distance. The distance of the display from the augmented reality device 202 may be combined with the position of the display within the field of view of the augmented reality device 202 to generate a factor, or weighting. An application programming interface (API) may be utilized to enable the augmented reality device 202 to identify, and control, content items playing on the different displays 208a, 208b, 208c, 208d, 208e, 208f and device 210. Such an API may be provided via the device itself and/or via an application provider, such as an OTT service provider.

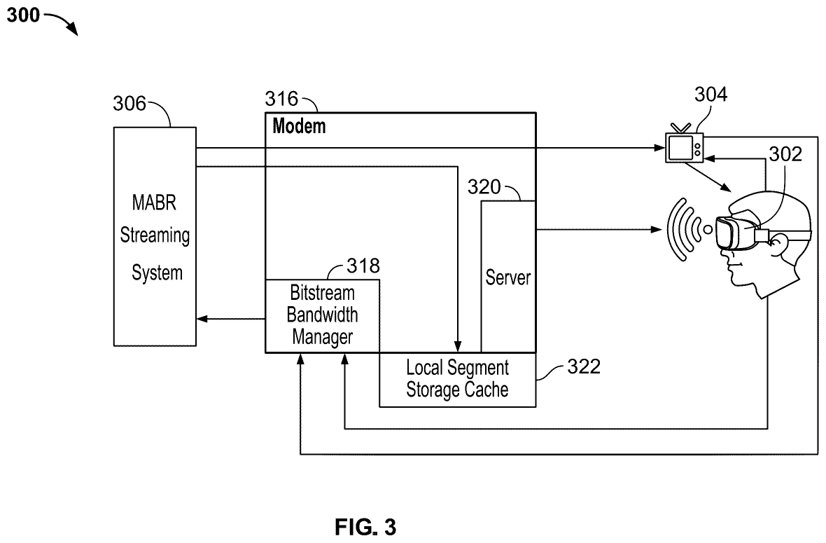

FIG. 3 shows another example environment in which bandwidth allocation for streams on virtual displays and physical devices is managed based on the field of vision of an extended reality device, in accordance with some embodiments of the disclosure. Environment 300 comprises an extended reality device 302, a physical television 304, a multicast adaptive bitrate (MABR) streaming system 306, and a modem 316. In some examples, the modem may be a router in addition to, or instead of, a modem. As described above, the physical television 304 receives a content item stream that can be controlled via extended reality device 302. The physical television 304 may comprise a digital decoder, or content streams may be decoded via a secondary device that is connected to the physical television 304, such as a cable or IPTV set-top box. Bandwidth may be managed via a suitable algorithm, such as one defined for Multicast ABR (MABR) and Unicast ABR (UABR) management. In addition, the extended reality device 302 receives content item streams that are used to generate virtual displays via multiple decoders, with each virtual display having, for example, its own audio and video decoder.

MABR streaming system 306 streams a plurality of channels to bitstream bandwidth manager 318. In some embodiments, bitstream bandwidth manager 318 may be configured for MABR. Each encoded MABR stream corresponds to a particular bitrate representation (e.g., 10 megabits per second (Mbs or Mbps) to 500 kilobits per second (Kbs or Kbps)) that correspond to various levels of video quality or resolutions) of a specific service channel to which a subscriber may tune for watching on a particular physical display or virtual display. Source feeds may comprise a variety of content or programs, e.g., pay TV broadcast programs delivered via cable networks or satellite networks, free-to-air satellite TV shows, IPTV programs, time-shifted/place-shifted TV (TS/PSTV) content, and the like. MABR streamlining system 306 transmits content item streams for the physical and virtual displays to modem 316. In some examples, these may be time shift television, or VOD, streams that utilize a real-time streaming protocol (RTSP) for controlling, for example, pause and/or trick modes, and/or a real-time transport protocol (RTP) to transmit the streams. The content item stream for the physical television 304 is delivered directly to physical television 304, via modem 316. The streams for the virtual displays are delivered via local segment storage cache 322, which may be a moving picture experts group (MPEG) dynamic adaptive streaming over HTTP (DASH) leveraging the common media application format (CMAF) compliant local segment storage cache 322 and server 320, which may be an HTTP server. Factors, or weights, are generated at the extended reality device 302 in the manner described in connection with FIG. 2 and pause requests and/or quality change requests are transmitted via bitstream bandwidth manager 318. The bandwidth manager 318 may be an MABR bitstream bandwidth manager which actions the request by transmitting an updated content item stream to the relevant device. This may comprise changing the quality of a stream. In some embodiments, changing the quality of a stream may be performed by leaving or joining MABR streams which are streaming at different bit rates. Requests may be transmitted from the extended reality device 302 via a suitable API that is provided by, for example, an OTT operator. A request to pause a stream will occur at the device itself and such requests may be transmitted to a backend system for controlling the switching of a stream from a live mode to a pause mode. A stream that is paused may have a weight of zero associated with it. The weight of zero removes the device stream from the bandwidth allocation.

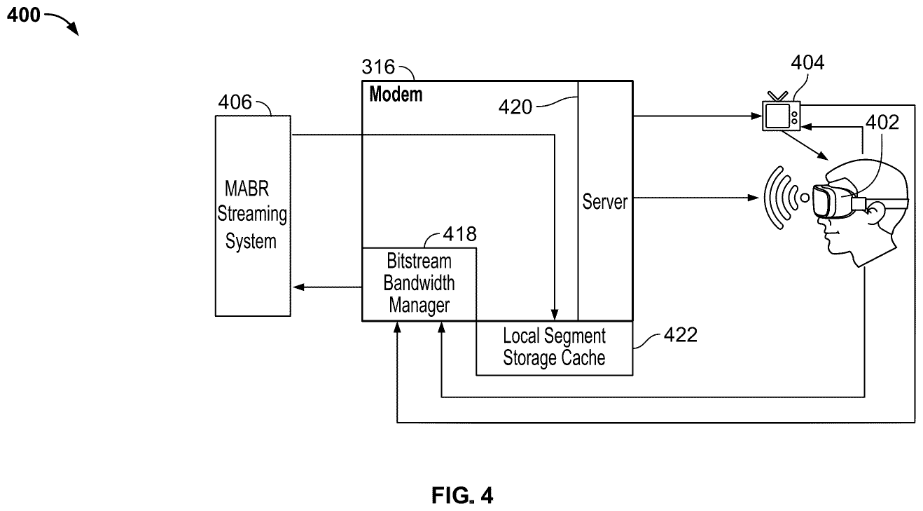

FIG. 4 shows another example environment in which bandwidth allocation for streams on virtual displays and physical devices is managed based on the field of vision of an extended reality device, in accordance with some embodiments of the disclosure. Environment 400 comprises an extended reality device 402, a physical television 404, a multicast adaptive bitrate (MABR) streaming system 406, and a modem 416. As described above, the physical television 404 receives a content item stream that can be controlled via extended reality device 402. The physical television 404 may run an application, such as an OTT application, or may be connected with a display-less OTT streaming device, such as an Amazon Fire TV Stick. Bandwidth may be managed via a suitable algorithm, such as one defined for UABR management. In addition, the extended reality device 402 receives content item streams that are used to generate virtual displays.

In some examples, modem 416 may be a router in addition to, or instead of, a modem. The streams for delivery to the physical television 404 (or the device connected to the physical television 404) and the extended reality device 402, for the virtual displays, are delivered via local segment storage cache 422. The local segment storage cache 422 may be a moving picture experts group (MPEG) dynamic adaptive streaming over HTTP (DASH) leveraging the common media application format (CMAF) compliant local segment storage cache and server 420, which may be an HTTP server. Factors, or weights, are generated at the extended reality device 402 in the manner described in connection with FIG. 2, and quality change requests are transmitted via bitstream bandwidth manager 418. The bitstream bandwidth manager 418 may be an MABR bitstream bandwidth manager which actions the request by transmitting an updated content item stream to the relevant device. This may comprise changing the quality of a stream by changing the bandwidth allocated to the stream. Requests may be transmitted from the extended reality device 402 via a suitable API, which is provided by, for example, an OTT operator. A request to pause a stream will occur at the device itself and such requests may be transmitted to a back-end system for controlling the switching of a stream from a live mode to a pause mode. A stream that is paused may have a weight of zero associated with it. The weight of zero removes the device stream from the bandwidth allocation. The weight change to zero allows for the bandwidth previously allocated to the now paused stream to be made available to other streams.

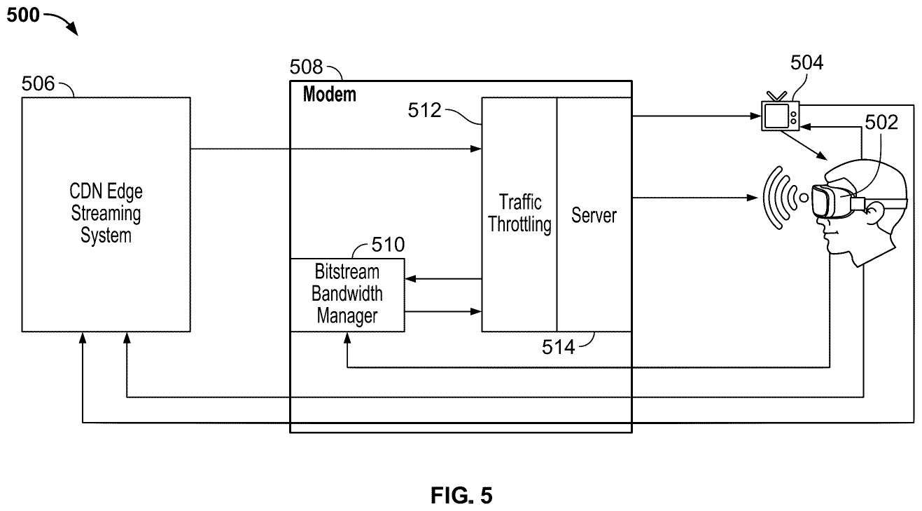

FIG. 5 shows another example environment in which bandwidth allocation for streams on virtual displays and physical devices is managed based on the field of vision of an extended reality device, in accordance with some embodiments of the disclosure. Environment 500 comprises an extended reality device 502, a physical television 504, a content delivery network (CDN) edge streaming system 506 and a modem 508. In some examples, the modem may be a router in addition to, or instead of, a modem. As described above, the physical television 504 receives a content item stream that can be controlled via extended reality device 502. The physical television 504 may run an application, such as an OTT application, or may be connected with a display-less OTT streaming device, such as an Amazon Fire TV Stick. Bandwidth may be managed via a suitable algorithm, such as one for managing flow control for OTT devices. In addition, the extended reality device 502 receives content item streams that are used to generate virtual displays.

CDN edge streaming system 506 streams a plurality of channels, each channel comprising a plurality of segments, to modem 508. At modem 508, traffic throttling module 512 is implemented, and the segments are transmitted to server 514, which may be an HTTP server. The streams are transmitted from the server 514 to the physical television 504 (or the device connected to the physical television 504) and the extended reality device 502, for the virtual displays. Factors, or weights, are generated at the extended reality device 502 in the manner described in connection with FIG. 2. Pause requests are transmitted to modem 508 and the pause action is taken at the device. Quality change requests are transmitted to bitstream bandwidth manager 510, which resides in modem 508. These quality change requests are transmitted to traffic throttling module 512, where they are actioned. The traffic throttling module 512 may also take into account additional throttling instructions, for example, an upper bandwidth limit set by a service provider. For example, a weight of zero is transmitted for the pause stream to the local router or modem.

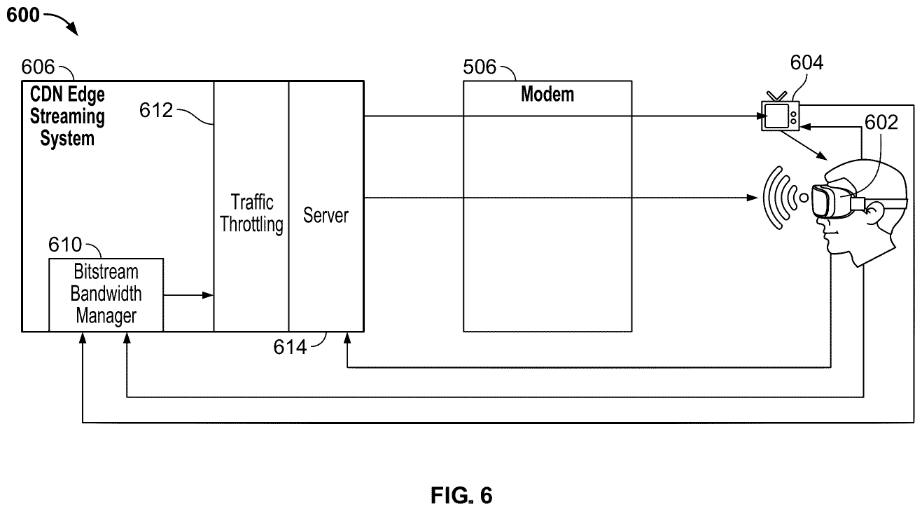

FIG. 6 shows another example environment in which bandwidth allocation for streams on virtual displays and physical devices is managed based on the field of vision of an extended reality device, in accordance with some embodiments of the disclosure. Environment 600 comprises an extended reality device 602, a physical television 604, a content delivery network (CDN) edge streaming system 606 and a modem 608. In some examples, the modem may be a router in addition to, or instead of, a modem. As described above, the physical television 604 receives a content item stream that can be controlled via extended reality device 602. The physical television 604 may run an application, such as an OTT application, or may be connected with a display-less OTT streaming device, such as an Amazon Fire TV Stick. Bandwidth may be managed via a suitable algorithm, such as one for managing flow control for OTT devices. In addition, the extended reality device 602 receives content item streams that are used to generate virtual displays.

CDN edge streaming system 606 comprises traffic throttling module 612; server 614, which may be an HTTP server; and bitstream bandwidth manager 610. The CDN edge streaming system 606 streams a plurality of channels, each channel comprising a plurality of segments, to modem 616. The streams are transmitted from the server 614 to the physical television 604 (or the device connected to the physical television 604) and the extended reality device 602, for the virtual displays. Factors, or weights, are generated at the extended reality device 602 in the manner described in connection with FIG. 2. Pause and quality change requests are actioned at the device and a weight of zero is transmitted to the CDN edge streaming system 606 and the bitstream bandwidth manager 610. The weight of zero allows the bandwidth previously allocated to the now paused stream to be made available for other streams. Quality change requests are transmitted to traffic throttling module 612, where they are actioned. The traffic throttling module 612 may also take into account additional throttling instructions, for example, an upper bandwidth limit set by a service provider. In some examples, a modeled pipe of the available bandwidth to the modem 616 may be modelled via a bandwidth estimation tool and/or defined via a user setting in an application.

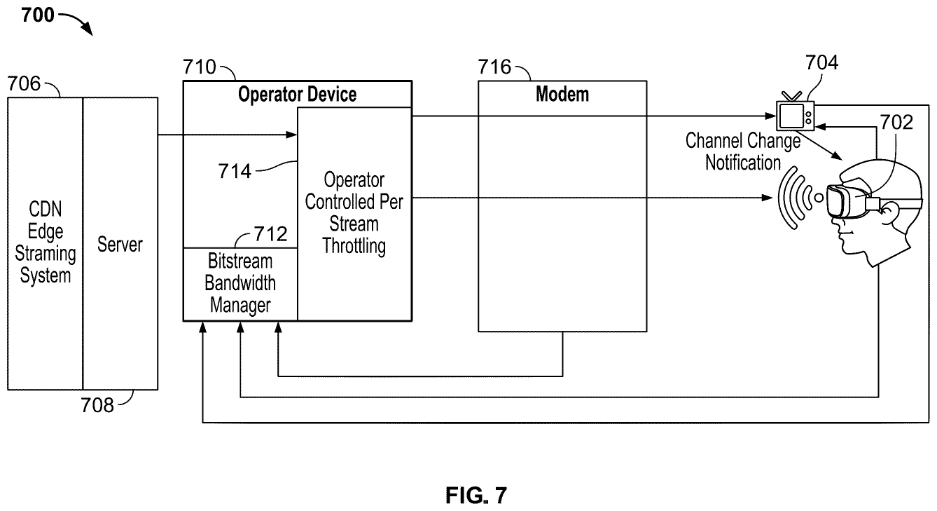

FIG. 7 shows another example environment in which bandwidth allocation for streams on virtual displays and physical devices is managed based on the field of vision of an extended reality device, in accordance with some embodiments of the disclosure. Environment 700 comprises an extended reality device 702, a physical television 704, a content delivery network (CDN) edge streaming system 706, an operator device 710 and a modem 716. In some examples, the modem may be a router in addition to, or instead of, a modem. As described above, the physical television 704 receives a content item stream that can be controlled via extended reality device 702. The physical television 704 may run an application, such as an OTT application, or may be connected with a display-less OTT streaming device, such as an Amazon Fire TV Stick. Bandwidth may be managed via a suitable algorithm, such as one for managing flow control for OTT devices. In addition, the extended reality device 702 receives content item streams that are used to generate virtual displays.

CDN edge streaming system 706 comprises server 708, which may be an HTTP server. A plurality of streams, each comprising a plurality of segments, are transmitted from the CDN edge streaming system 706 to the operator device 710. The operator device 710 may comprise, for example, a broadband network gateway, a cable model termination system and/or a 5G edge device. The operator device comprises an operator-controlled per stream throttling module 714 and a bitstream bandwidth manager 712. The streams are transmitted from the operator device 710 to the physical television 704 (or the device connected to the physical television 704) and the extended reality device 702, for the virtual displays. Factors, or weights, are generated at the extended reality device 702 in the manner described in connection with FIG. 2. Pause and quality change requests are actioned at the device while a weight of zero is transmitted to the operator device 710 and bitstream bandwidth manager 612. Quality change requests are transmitted to operator-controlled per stream throttling module 714, where they are actioned. The operator-controlled per stream throttling module 714 may also take into account additional throttling instructions, for example, an upper bandwidth limit set by a service provider.

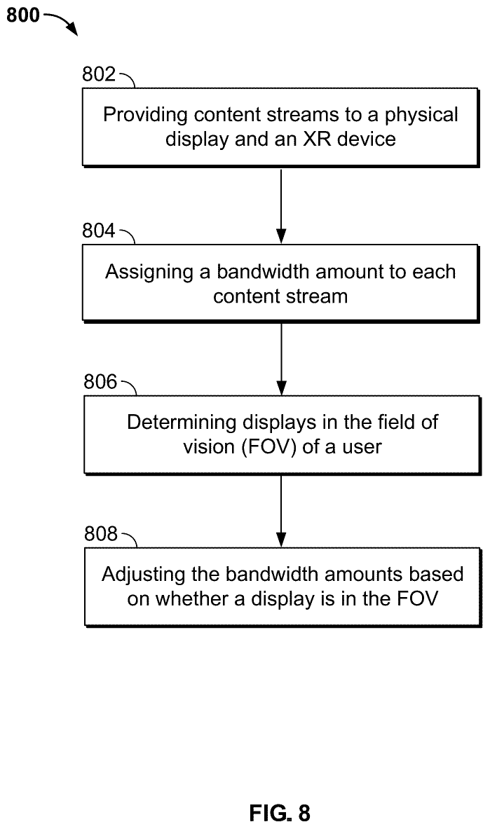

FIG. 8 shows a flowchart of illustrative steps involved in managing bandwidth in a network including physical devices and XR devices, in accordance with some embodiments of the disclosure. Generally, the process includes providing content streams to a physical display and an XR device, assigning a bandwidth amount to each content stream, determining displays in the field of vision (FOV) of a user, and adjusting the bandwidth amounts based on whether a display is in the FOV. For instance, bandwidth may be dynamically reallocated while a user is watching multiple football games at one time on one or more network-connected TV screens, monitors, smartphones, and/or tablets, as well as multiple virtual displays using an XR device. Process 800 may be implemented on any of the aforementioned computing devices, e.g., extended reality device 202, 302, 402, 502, 602, 702, which could be working in conjunction with local network devices and/or remote servers. In addition, one or more actions of the process 800 may be incorporated into or combined with one or more actions of any other process or embodiments described herein.

At 802, a physical display and an XR device receive content streams, e.g., from one or more content delivery networks. FIG. 1, for example, depicts a spatially mapped room where, e.g., physical display 102a might feature a first football game (e.g., a nationally televised game), physical display 102b might feature a second football game (e.g., with a favorite team), virtual display 102c might display a third football game (e.g., a really close game about to finish), virtual display 102d might display a news program, and virtual display 102e might feature a business news program. In some embodiments, content streams may be provided to more than one physical display on the network. In some embodiments, more than one content stream may be provided to the XR device, e.g., as virtual displays.

At 804, each content stream is assigned a bandwidth by, for example, a bitstream bandwidth manager. For instance, looking at environment 100 in FIG. 1, the football games on displays 102a, 102b, and 102c might be streamed at, e.g., 1920×1080 resolution and 4300 kbps each, while the news programs on virtual displays 102d and 102e might be streamed at, e.g., 1280×720 resolution and 2350 kbps each. In some embodiments,

At 806, the field of vision of a user of the XR device is determined and displays within that field of vision are identified. Generally, an XR device may measure a gaze point and/or head orientation to determine the field of view. For instance, using a determined gaze point or head orientation, as well as a known angular measurement(s) for the view, an area within the field of view may be determined, e.g., for a spatially mapped room. The system can then determine which physical displays and virtual displays fall in the FOV e.g., in the spatially mapped room. For example, in FIG. 1, the XR device may determine that the field of view covers the football games on displays 102b and 102c.

At 808, the bandwidth amounts assigned to the content streams are adjusted based on which displays are in the field of vision of the user. For example, in FIG. 1, if the XR device may determine that the field of view covers the football games on displays 102b and 102c, more bandwidth may be allocated to displays 102b and 102c and less bandwidth may be allocated to displays 102a, 102d, and 102e, e.g., while displays 102b and 102c are in the FOV. As a result, for instance, the football games on displays 102b and 102c might be streamed at, e.g., 3840×2160 resolution and 1.84 Mbps each, while the football game on display 102a might be streamed at, e.g., 1280×720 resolution and 2350 kbps and news programs on virtual displays 102d and 102e might be streamed at, e.g., 720×480 resolution and 1750 kbps each.

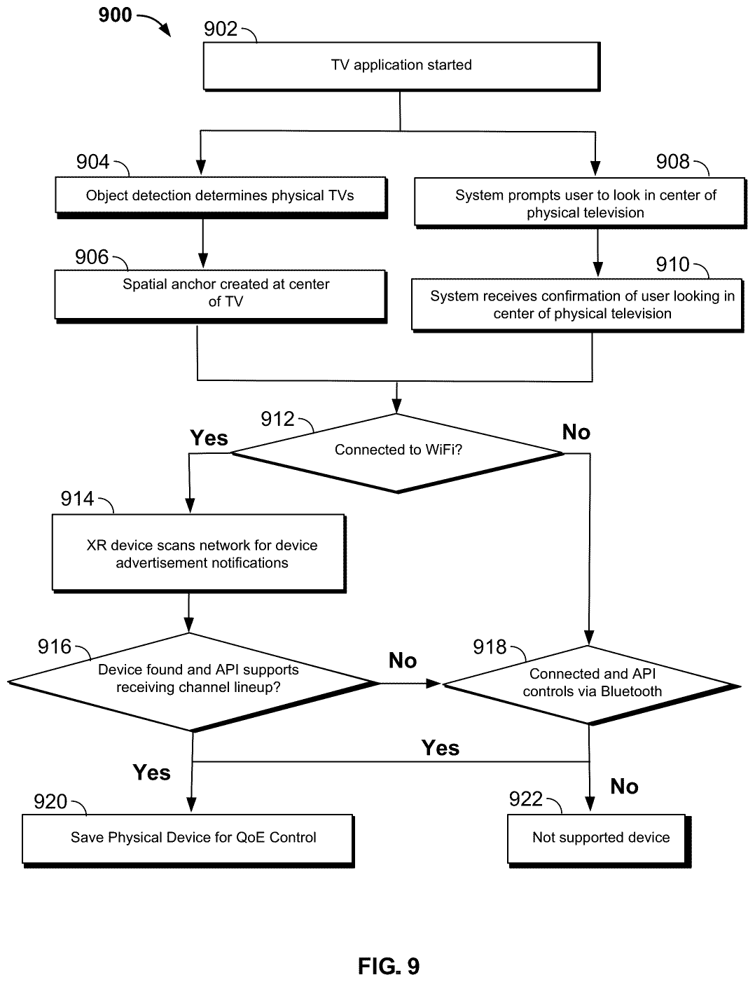

FIG. 9 shows a flowchart of illustrative steps involved in identifying physical TVs, in accordance with some embodiments of the disclosure. Generally, the process includes detecting physical TVs on which a television application is running and determining if the physical TV is a supported device. Process 900 may be implemented on any of the aforementioned computing devices (e.g., extended reality device 202, 302, 402, 502, 602, 702). In addition, one or more actions of the process 900 may be incorporated into or combined with one or more actions of any other process or embodiments described herein.

At 902, a TV application is started. The XR device detects the physical TV by either going to step 904 or step 908. At 904, object detection in the XR determines the physical TVs in the line of sight of the user. Alternately, at 906, a spatial anchor is created at the center of the TV. At 908 the system prompts the user to look at the center of the physical TV. At 910, the system receives confirmation of user looking in center of physical television. In some embodiments, this confirmation is received by detection of hand gesture or voice recognition.

After detecting the physical TV by either method, the XR device detects if it is connected to a WiFi network. If it is, it continues to step 914 and scans the network for device advertisement notifications. At 916, if a device is found and API supports receiving channel lineup the physical device can be saved for QoE control at 920. If the XR is found at 912 to not be connected to WiFi, at 918, the XR checks for devices connected via Bluetooth and the API supports controlling the device. If it is not connected via Bluetooth or the API does not support it, the device is not supported at 922. If the device is supported, then at 920 it is saved for QoE control.

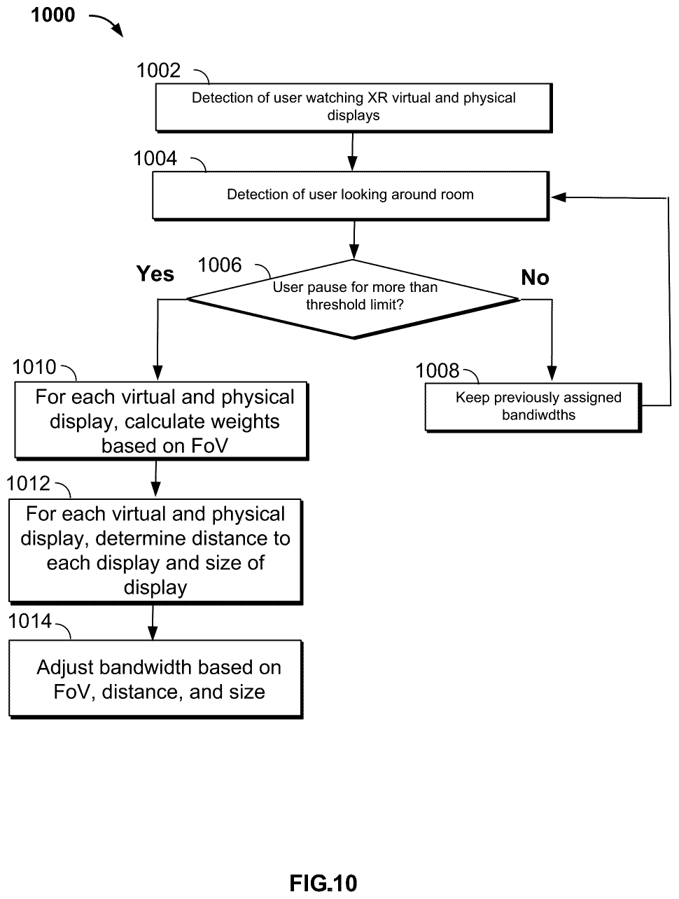

FIG. 10 shows a flowchart of illustrative steps involved in adjusting the bandwidth for physical and AR TVs based on weight changes, in accordance with some embodiments of the disclosure. Process 1000 may be implemented on any of the aforementioned computing devices (e.g., extended reality device 202, 302, 402, 502, 602, 702). In addition, one or more actions of the process 900 may be incorporated into or combined with one or more actions of any other process or embodiments described herein.

At 1002, the system detects that a user is watching XR virtual and physical displays. FIG. 1, for example, depicts a spatially mapped room where, e.g., physical display 102a might feature a first football game (e.g., a nationally televised game), physical display 102b might feature a second football game (e.g., with a favorite team), virtual display 102c might display a third football game (e.g., a really close game about to finish), virtual display 102d might display a news program, and virtual display 102e might feature a business news program. At 1004, the system detects that the user looks around the room, as explained in reference to FIGS. 1, 2, and 8. At 1006, the system determines if the user paused for more than the threshold limit of time. For example, a user's previous field of vision may have included physical display 102b and virtual display 102c because these display included a game with a favorite team and a very close game close to ending. However, a user may look around the room such that their field of vision now includes other displays in addition or instead of physical display 102b and virtual display 102c (e.g. physical display 102a, virtual display 102d, and virtual display 102e). If not, then at 1008 the previously assigned bandwidths are kept and the user continues to look around the room. For example, if the user is excited about an event in the game on one of the displays in their field of vision and turns to high-five their friend, they will not pause to look at one display for longer than a threshold. In this case, the user will turn back to the original field of vision to continue watching the games they were watching and the bandwidth should not be updated from where they were previously.

If it is determined at 1006 that the user paused for more than the threshold limit of time, for each virtual and physical display, weights for bandwidth allocation are recalculated based on the field of vision of the user, as explained in reference to FIGS. 1, 2 and 8. For example, if a user is primarily watching their favorite team on display 102b, but turns to focus on display 102c as the game ends, 102d when there is breaking news, and/or potentially display 102e to see how the market is reacting, the user will pause for more than a threshold and the bandwidth should be readjusted to provide the user with a better viewing experience within their new view of vision. At 1012, for each virtual and physical display, the distance to each display and size of display are determined. At 1012, based on FoV, distance, and size, the bandwidth is adjusted, as explained in reference to FIGS. 1 and 2.

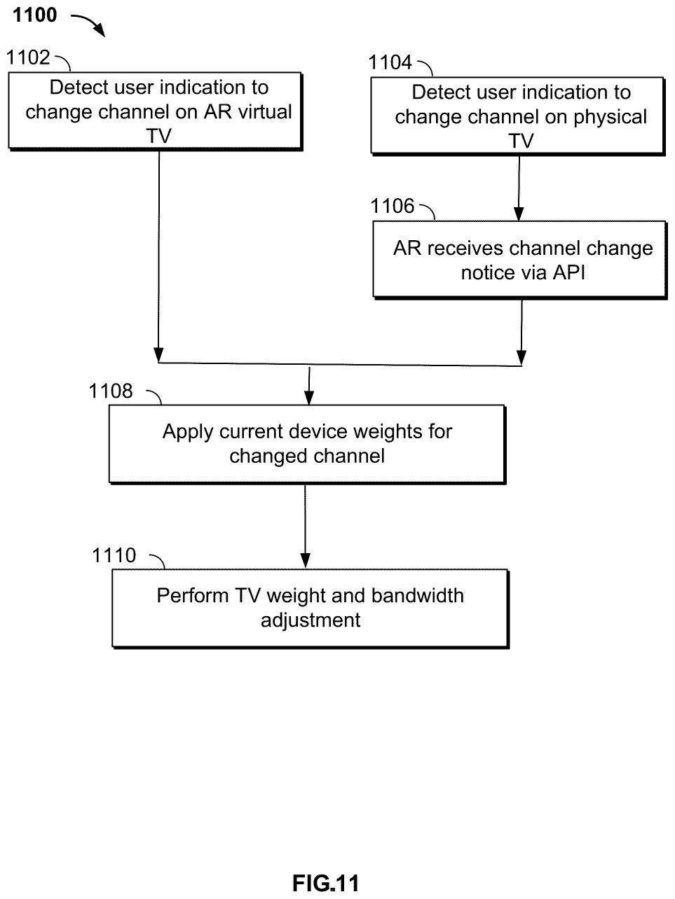

FIG. 11 shows a flowchart of illustrative steps involved in changing AR virtual TV channels or physical TV or STB channels, in accordance with some embodiments of the disclosure. Process 1100 may be implemented on any of the aforementioned computing devices (e.g., extended reality device 202, 302, 402, 502, 602, 702). In addition, one or more actions of the process 1100 may be incorporated into or combined with one or more actions of any other process or embodiments described herein.

At 1102 the system detects a user indication to change the channel on an AR virtual TV. At 1104, the system detects a user indication to change the channel on a physical TV. In some embodiments, the user may change the channels on the physical TV or STB using the TV or STB remote. In some embodiments, the user may change the channels on the physical TV using the AR device. At 1106, the AR receives the channel change notice via API.

At 1108, current device weights are applied for the changed channel. At 110, TV weight and bandwidth adjustment is performed, as explained in reference to FIGS. 1 and 2.

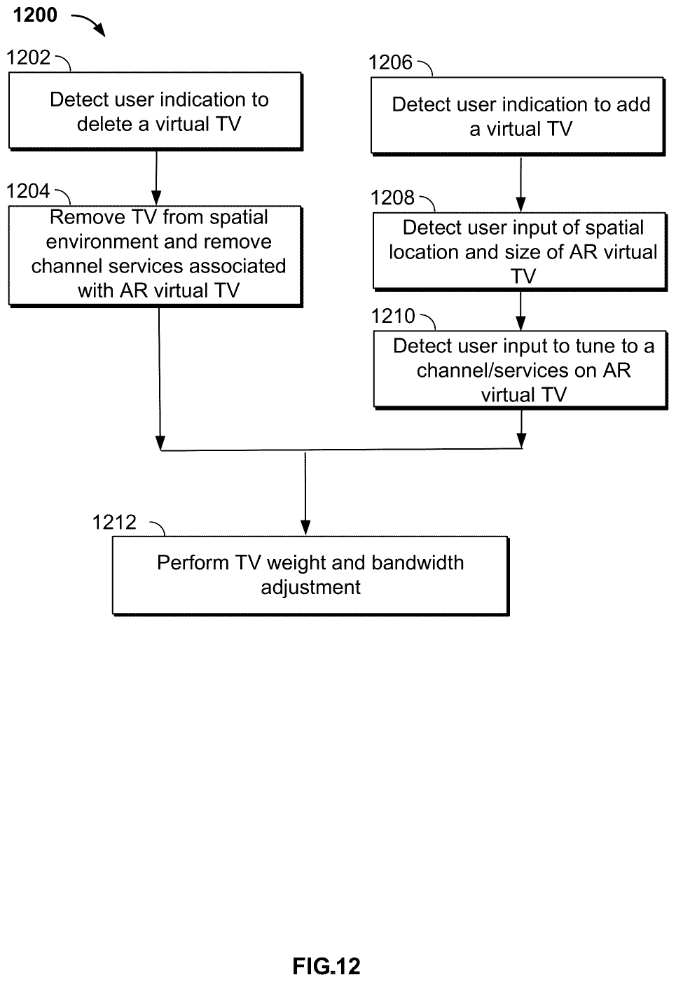

FIG. 12 shows a flowchart of illustrative steps involved in adding or deleting AR virtual TVs, in accordance with some embodiments of the disclosure. Process 1200 may be implemented on any of the aforementioned computing devices (e.g., extended reality device 202, 302, 402, 502, 602, 702). In addition, one or more actions of the process 1200 may be incorporated into or combined with one or more actions of any other process or embodiments described herein.

At 1202, the system detects a user indication to delete a virtual TV and at 1204 the virtual TV is removed from the spatial environment and channel services which were associated with the AR virtual TV are removed. At 1206, the system detects a user indication to add a virtual TV. At 1208, the system detects a user input indicating the spatial location and size of the AR virtual TV. At 1210, the system detects user input indicating to tune to a channel or media service on the AR virtual TV. At 1212, TV weight and bandwidth adjustment are performed in response to adding or deleting a virtual TV. Bandwidth adjustment may be made in the manner explained in reference to FIGS. 1 and 2.

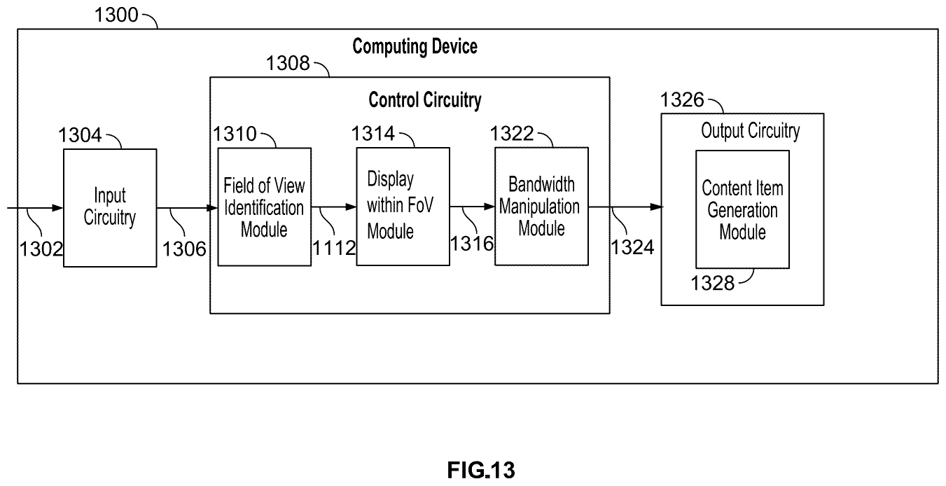

FIG. 13 shows a block diagram representing computing device components and dataflow therebetween for managing bandwidth in a network with an extended reality device and physical device, in accordance with some embodiments of the disclosure. Computing device 1300 (e.g., augmented reality device 202, 302, 402, 502, 602, 702), as discussed above, comprises input circuitry 1304, control circuitry 1308 and output circuitry 1326. Control circuitry 1308 may be based on any suitable processing circuitry (not shown) and comprises control circuits and memory circuits, which may be disposed on a single integrated circuit or may be discrete components and processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i5 processor and an Intel Core i7 processor) and/or a system on a chip (e.g., a Qualcomm Snapdragon 888). Some control circuits may be implemented in hardware, firmware, or software.

Input is received 1302 by the input circuitry 1304. The input circuitry 1304 is configured to receive inputs related to a computing device. For example, this may be via gesture detected via an extended reality device. In other examples, this may be via an infrared controller, Bluetooth and/or Wi-Fi controller of the computing device 1300, a touchscreen, a keyboard, a mouse and/or a microphone. In another example, the input may comprise instructions received via another computing device. The input circuitry 1304 transmits 1306 the user input to the control circuitry 1308.

The control circuitry 1308 comprises a field-of-view identification module 1310, display within field of view determination module 1314, and a bandwidth manipulation module 1322. The input is transmitted to the field of view identification module 1310, where a field-of-view of an extended reality device is determined. An indication of the field-of-view is transmitted 1312 to the display within field of view determination module 1314, where it is determined if, and how many, displays fall within the field of view. An indication of the displays that fall within the field of view is transmitted 1316 to the bandwidth manipulation module 1322 where instructions to manipulate the bandwidth for a stream sent to at least one of the identified displays are generated. In some embodiments, these instructions may be a weighting factor which dictates the amount of bandwidth allocated to the stream. These instructions are transmitted 1324 to the output circuitry 1326, where the content item generation module 1328 generates the content item for display based on the instructions from the bandwidth manipulation module 1322.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for managing bandwidth in a network, the method comprising:
providing a plurality of content streams via a plurality of displays comprising at least one physical display of an electronic device and at least one virtual display provided via an extended reality (XR) device;
assigning a bandwidth amount to each content stream of the plurality of streams;
determining a field of vision of a user of the XR device;
determining a subset of the plurality of displays that are in the field of vision of the user; and
adjusting the bandwidth amount assigned to at least one of the plurality of content streams based on the subset of the plurality of displays that are in the field of vision of the user.

2. The method of claim 1 further comprising:
determining an updated field of vision of the user;
based on determining that a second subset of the plurality of displays are in the updated field of vision of the user, readjusting the bandwidth amount assigned to at least one of the plurality of content streams.

3. The method of claim 1 wherein the adjusting the bandwidth amount assigned to at least one of the plurality of displays comprises:
based on determining that the at least one of the plurality of content streams is provided via a display in the subset of the plurality of displays that are in the field of vision of the user, increasing the bandwidth amount assigned to the at least one of the plurality of content streams.

4. The method of claim 1 wherein the adjusting the bandwidth amount assigned to at least one of the plurality of streams comprises:
based on determining that the at least one of the plurality of content streams is provided via a display not in the subset of the plurality of displays that are in the field of vision of the user, decreasing the bandwidth amount assigned to the at least one of the plurality of content streams.

5. The method of claim 1 further comprising:
receiving, from the user, a first request to view a first content stream at the virtual display provided via the XR device;
receiving, from the user, a second request to view a second content stream at the physical display of the electronic device.

6. The method of claim 1 further comprising adjusting the bandwidth amount assigned to at least one of the plurality of content streams based on a size of each display of the plurality of displays.

7. The method of claim 1 further comprising adjusting the bandwidth amount assigned to at least one of the plurality of content streams based on a distance from the XR device to each display of the plurality of displays.

8. The method of claim 1 further comprising adjusting the bandwidth amount assigned to at least one of the plurality of content streams based on a content type of the content stream.

9. The method of claim 1, wherein determining a subset of the plurality of displays that are in the field of vision of the user comprises:
determining a position for each display of the plurality of displays;
determining coordinates for the field of vision of the user;
determining, for each display of the plurality of displays, whether the respective position is within the coordinates for the field of vision of the user.

10. The method of claim 1, further comprising:
receiving an indication from the user to designate a first content stream of the plurality of content streams as a priority stream;
wherein the adjusting the bandwidth amount assigned to at least one of the plurality of content streams further comprises adjusting a bandwidth amount assigned to a content stream other than the priority stream.

11. The method of claim 1, wherein the adjusting the bandwidth amount assigned to at least one of the plurality of content streams occurs at one of a gateway and content delivery network (CDN) edge.

12-21. (canceled)

22. A system comprising:
a physical display of an electronic device;
an XR device configured to determine a field of vision of a user of the XR device; and
a network device configured to:
provide a plurality of content streams via a plurality of displays comprising at least the physical display of the device and a virtual display provided via the XR device;
determine a subset of the plurality of displays that are in the field of vision of the user;
assign a bandwidth amount to each content stream of the plurality of streams; and
adjust the bandwidth amount assigned to at least one of the plurality of content streams based on the subset of the plurality of displays that are in the field of vision of the user.

23. The system of claim 22 wherein the XR device is further configured to determine an updated field of vision of the user; and
the network device is further configured to:
based on determining that a second subset of the plurality of displays are in the updated field of vision of the user, readjust the bandwidth amount assigned to at least one of the plurality of content streams.

24. The system of claim 22 wherein, when adjusting the bandwidth amount assigned to at least one of the plurality of displays, the network device is further configured to:
based on determining that the at least one of the plurality of content streams is provided via a display in the subset of the plurality of displays that are in the field of vision of the user, increase the bandwidth amount assigned to the at least one of the plurality of content streams.

25. The system of claim 22 wherein, when adjusting the bandwidth amount assigned to at least one of the plurality of stream, the network device is further configured to:
based on determining that the at least one of the plurality of content streams is provided via a display not in the subset of the plurality of displays that are in the field of vision of the user, decreasing the bandwidth amount assigned to the at least one of the plurality of content streams.

26. The system of claim 22 wherein the network device is further configured to:
receive a first request to view a first content stream at the virtual display provided via the XR device;
receive a second request to view a second content stream at the physical display of the electronic device.

27. The system of claim 22 wherein the network device is further configured to adjust the bandwidth amount assigned to at least one of the plurality of content streams based on a size of each display of the plurality of displays.

28. The system of claim 22 wherein the network device is further configured to adjust the bandwidth amount assigned to at least one of the plurality of content streams based on a distance from the XR device to each display of the plurality of displays.

29. The system of claim 22 wherein the network device is further configured to adjust the bandwidth amount assigned to at least one of the plurality of content streams based on a content type of the content stream.

30. The system of claim 22, wherein when determining a subset of the plurality of displays that are in the field of vision of the user, the network device is further configured to:
determine a position for each display of the plurality of displays;
determine coordinates for the field of vision of the user;
determine, for each display of the plurality of displays, whether the respective position is within the coordinates for the field of vision of the user

31. The system of claim 22, wherein one of the electronic device and the XR device is further configured to receive an indication from the user to designate a first content stream of the plurality of content streams as a priority stream; and
wherein, when adjusting the bandwidth amount assigned to at least one of the plurality of content streams, the network device is further configured to adjust a bandwidth amount assigned to a content stream other than the priority stream.

32-42. (canceled)
